(19) United States
(12) Patent Application Publication
(10) Pub. No.: US 2012/0120532 A1
(43) Pub. Date: May 17, 2012

(54) PRINTED WIRING BOARD

(75) Inventor: Keita TAKANASHI, Tokyo (JP)

(73) Assignees: SANYO OPTEC DESIGN CO., LTD., Tokyo (JP); SANYO ELECTRIC CO., LTD., Osaka (JP)

(21) Appl. No.: 13/294,521

(22) Filed: Nov. 11, 2011

(30) Foreign Application Priority Data
Nov. 15, 2010 (JP) 2010-254888

(51) Int. Cl. H02H 9/04

(52) U.S. Cl. 361/56

(57) ABSTRACT

A printed wiring board includes: an anode pattern electrically connected to an anode of a laser diode; and a cathode pattern arranged to oppose the anode pattern and electrically connected to a cathode of the laser diode, the anode pattern and the cathode pattern being in shapes having such parts that a distance between the anode pattern and the cathode pattern opposed to each other is a first distance, and such parts that a distance between the anode pattern and the cathode pattern opposed to each other is a second distance shorter than the first distance, at least such parts that the distance between the anode pattern and the cathode pattern opposed to each other is the second distance being short-circuited by solder in a case where the laser diode is protected from an electrostatic discharge.

### CROSS-REFERENCE TO RELATED APPLICATION

This application claims the benefit of priority to Japanese Patent Application No. 2010-254888, filed Nov. 15, 2010, of which full contents are incorporated herein by reference.

### BACKGROUND OF THE INVENTION

1. Field of the Invention

The present invention relates to a printed wiring board to be used in an optical pickup apparatus configured to perform an operation of reading a signal recorded in an optical disc using a laser beam.

2. Description of the Related Art

Optical disc devices are in widespread use that are capable of performing an operation of reproducing a signal and an operation of recording a signal by irradiating a signal recording layer of an optical disc with a laser beam emitted from an optical pickup apparatus.

While the optical disc device which uses the optical disc called CD or DVD is in general use, the optical disc device which uses the optical disc with recording density thereof improved, namely, a Blu-ray optical disc, has recently been developed.

The optical pickup apparatus is configured to condense the laser beam emitted from a laser diode onto a signal recording layer included in the optical disc by a focusing operation of an object lens, as well as irradiate a photodetector with return light, which is the laser beam reflected from the signal recording layer.

The optical disc device has been commercialized that is capable of using all the optical discs of the CD-standard optical disc, the DVD-standard optical disc, and the Blu-ray-standard optical disc described above, and the optical pickup apparatus, which is used in such an optical disc device, is configured to be able to perform an operation of reading a signal recorded in all the optical discs.

Such an optical pickup apparatus includes the laser diode which is configured to generate and emit a first laser beam, a second laser beam, and a third laser beam having different wavelengths, and such a laser diode generally includes: a laser diode configured to emit the laser beam to read a signal recorded in the Blu-ray-standard optical disc; and a so-called two-wavelength laser diode, in which a first laser diode configured to emit the laser beam to read a signal recorded in the CD-standard optical disc and a second laser diode configured to emit the laser beam to read a signal recorded in the DVD-standard optical disc are incorporated in a single housing.

The laser diode included in the optical pickup apparatus, which is configured to perform the operation of reading a signal recorded in the optical disc, has a problem of being damaged by static electricity. In order to protect the laser diode from such an electrostatic discharge, generally used is a method that a printed wiring board to be incorporated in the optical pickup apparatus is provided with a short-circuit-use land for short-circuiting a power supply terminal and a ground terminal of the laser diode and the power supply terminal and the ground terminal are being short-circuited until when the optical pickup apparatus is incorporated into the optical disc device. Such a technique includes a technique disclosed in Japanese Laid-Open Patent Publication No. 2007-193921.

The technique of protecting the laser diode from the electrostatic discharge will be described with reference to FIGS. 6A and 6B. FIG. 6A is an explanatory diagram of a relationship between a pattern wired on the printed wiring board and the laser diode, and for example, an anode pattern 2 connected to an anode which is a power supply terminal of a laser diode 1 and a cathode pattern 3 connected to a cathode which is a ground terminal of the laser diode 1 are provided.

In the figure, a hatched part 2A of the anode pattern 2 is a resist coating and a part thereof 2B not coated with the resist coating is an anode solder pattern which is to be soldered. Similarly, a hatched part 3A of the cathode pattern 3 is a resist coating and a part thereof 3B not coated with the resist coating is a cathode solder pattern to be soldered.

Soldering is performed in a state where a component such as the laser diode 1 is mounted on the printed wiring board on which the above-described patterns have been wired, and the soldering is generally performed by a method called reflow. The reflow is a method of fixing an electronic component to the printed wiring board, which is called surface mounting, and a configuration is such that the electronic component is mounted in a state where cream solder is coated and then the electronic component is electrically fixed by means of soldering to the patterns, formed on the printed wiring board, by applying high temperature treatment thereto.

FIG. 6B depicts a state where the electronic component is fixed onto the printed wiring board by a reflow operation, and reference numeral 4 denotes the cream solder. That is to say, as is apparent from the figure, a state is such that the anode solder pattern 2B and the cathode solder pattern 3B are electrically connected by the cream solder 4, i.e., a state where they are short-circuited. The cream solder 4 acts as the solder for short-circuit.

In such a state, since the anode that is the power supply terminal of the laser diode 1 and the cathode that is the ground terminal thereof are short-circuited, which results in a sate where the laser diode 1 can be protected from the electrostatic discharge.

In such a state, in the case where an operation of adjusting the optical pickup apparatus is performed by supplying a drive signal to the laser diode 1 or in the case where an operation of assembling it to the optical disc device is to be completed, it is required to release the state where the anode and the cathode of the laser diode 1 are short-circuited. Such an operation is performed by fusing the cream solder 4 as the above-described solder for short circuit with a soldering iron, etc., to separate the anode solder pattern 2B and the cathode solder pattern 3B as illustrated in FIG. 6A.

In the optical pickup apparatus, it is necessary to perform an operation of releasing short-circuit to change a state from a short-circuit state illustrated in FIG. 6B to a non-short-circuit state illustrated in FIG. 6A by fusing and removing the cream solder 4, and an operation of short-circuiting to change a state from the non-short-circuit state illustrated in FIG. 6A to the short-circuit state illustrated in FIG. 6B by fusing and applying the cream solder 4.

The operation of short-circuiting the anode solder pattern 2B and the cathode solder pattern 3B and the operation of releasing the short-circuit thereof are to be performed at least three times, i.e., at the time of assembling the optical pickup apparatus, at the time of performing an optical adjustment, and at the time of incorporating it into an optical disc device, as described in Japanese Laid-Open Patent Publication No. 2007-193921.

While the short-circuiting operation and the short-circuit releasing operation are performed with the soldering iron, etc., heat resistance is required to perform such operations, and therefore the anode solder pattern 2B and the cathode solder pattern 3B are required to have a certain size. In a case where the anode solder pattern 2B and the cathode solder pattern 3B are of large size, the amount of the cream solder is increased to short-circuit these patterns by the reflow operation.

The anode solder pattern 2B and the cathode solder pattern 3B are in shapes illustrated in FIG. 6A, namely, patterns opposed to each other are arranged in a linear manner and parallel to each other. In such a configuration, if a space between the anode solder pattern 2B and the cathode solder pattern 3B is too wide, which leads to a problem that the short-circuiting operation cannot easily be performed, and to the contrary, if the space is too narrow, which leads to a problem that the short-circuit releasing operation cannot easily be performed.

### SUMMARY OF THE INVENTION

A printed wiring board according to an aspect of the present invention, includes: an anode pattern electrically connected to an anode of a laser diode; and a cathode pattern arranged to oppose the anode pattern and electrically connected to a cathode of the laser diode, the anode pattern and the cathode pattern being in shapes having such parts that a distance between the anode pattern and the cathode pattern opposed to each other is a first distance, and such parts that a distance between the anode pattern and the cathode pattern opposed to each other is a second distance shorter than the first distance, at least such parts that the distance between the anode pattern and the cathode pattern opposed to each other is the second distance being short-circuited by solder in a case where the laser diode is protected from an electrostatic discharge.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1A is an explanatory diagram illustrating a first embodiment of a printed wiring board according to the present invention;

FIG. 1B is an explanatory diagram illustrating a first embodiment of a printed wiring board in an other state according to the present invention;

FIG. 2 is an explanatory diagram illustrating a second embodiment of a printed wiring board according to the present invention;

FIG. 3 is an explanatory diagram illustrating a third embodiment of a printed wiring board according to the present invention;

FIG. 4 is an explanatory diagram of a fourth embodiment of a printed wiring board according to the present invention;

FIG. 5 is an explanatory diagram illustrating a fifth embodiment of a printed wiring board according to the present invention;

FIG. 6A is an explanatory diagram illustrating a printed wiring board; and

FIG. 6B is an explanatory diagram illustrating a printed wiring board in an other state.

### DETAILED DESCRIPTION OF THE INVENTION

At least the following details will become apparent from descriptions of this specification and of the accompanying drawings.

A printed wiring board according to an embodiment of the present invention has an anode pattern and a cathode pattern arranged close to each other on the printed wiring board, the anode pattern connected to an anode of a laser diode and supplied with a drive signal, the cathode pattern connected to a cathode of the laser diode and grounded, and the printed wiring board is configured to protect the laser diode from an electrostatic discharge by short-circuiting the anode pattern and the cathode pattern with solder, wherein the anode pattern has a protruding projection pattern provided (formed) in a part thereof and the cathode pattern has a protruding projection pattern provided (formed) in a part thereof, the parts thereof opposed to each other.

A printed wiring board according to an embodiment of the present invention has an anode pattern and a cathode pattern arranged close to each other on the printed wiring board, the anode pattern connected to an anode of the laser diode and supplied with a drive signal, and the cathode pattern connected to a cathode of the laser diode and grounded, and the printed wiring board is configured to protect the laser diode from an electrostatic discharge by short-circuiting the anode pattern and the cathode pattern with solder, wherein the anode pattern has a part thereof in a wave form and the cathode pattern has a part thereof in a wave form, the parts thereof opposed to each other.

A printed wiring board according to an embodiment of the present invention has a first anode pattern, a second anode pattern, and a cathode pattern arranged close to one another on the printed wiring board, the first anode pattern connected to an anode of a first laser diode and supplied with a drive signal, the second anode pattern connected to an anode of a second laser diode and supplied with a drive signal, and a cathode pattern connected to a cathode of the first laser diode and a cathode of the second laser diode and grounded, and the printed wiring board is configured to protect the first laser diode and the second laser diode from an electrostatic discharge by short-circuiting the first and second anode patterns and the cathode pattern with solder, wherein protruding projection patterns are provided in parts opposed to each other of the first anode pattern and the cathode pattern and in parts opposed to each other of the second anode pattern and the cathode pattern.

A printed wiring board according to an embodiment of the present invention has a first anode pattern, a second anode pattern, and a cathode pattern arranged close to one another on the printed wiring board, the first anode pattern connected to an anode of a first laser diode and supplied with a drive signal, the second anode pattern connected to an anode of a second laser diode and supplied with a drive signal, and a cathode pattern, connected to a cathode of the first laser diode and a cathode of the second laser diode and grounded, and the printed wiring board is configured to protect the first laser diode and the second laser diode from an electrostatic discharge by short-circuiting the first and second anode patterns and the cathode pattern with solder, wherein the first anode pattern and the cathode pattern have parts thereof opposed to each other which parts are in a wave form and the second anode pattern and the cathode pattern have parts thereof opposed to each other which parts are in a wave form.

The printed wiring board according to an embodiment of the present invention has the cathode pattern arranged between the first anode pattern and the second anode pattern.

The printed wiring board according to an embodiment of the present invention has soldering parts each in a fan-like form of a first anode pattern, a second anode pattern, and a cathode pattern, the three soldering parts arranged in a circular form.

The printed wiring board according to an embodiment of the present invention includes the first anode pattern having a projection pattern provided (formed) in a part thereof and the second anode pattern having a projection pattern provided (formed) in a part thereof, the parts thereof opposed to each other.

The printed wiring board according to an embodiment of the present invention includes the first anode pattern having a part thereof in a wave form and the second anode pattern having a part thereof in a wave form, the parts thereof opposed to each other.

The printed wiring board according to an embodiment of the present invention has a plurality of the projection patterns provided therein.

In the printed wiring board according to an embodiment of the present invention, the projection patterns, which are formed in the parts opposed to each other of the anode pattern and the cathode pattern, are provided to protect the laser diode from the electrostatic discharge, that is to say, a space between the anode pattern and the cathode pattern has a wide part and a narrow part, thereby being able not only to bring about the short-circuit state with a small amount of solder but also to perform a short-circuit releasing operation easily and securely.

In the printed wiring board according to an embodiment of the present invention, the cathode pattern is commonly used as a single pattern which is to be soldered to the first anode pattern and the second anode pattern which are connected to the anodes of the laser diodes as in a two-wavelength laser diode, thereby securing an advantage that a wiring pattern is simplified.

In the printed wiring board according to an embodiment of the present invention, the first anode pattern, the second anode pattern, and the cathode pattern each are in a fan-like form and the three patterns are arranged in a circular form, thereby securing an advantage that all the patterns can be short-circuited by soldering the central part thereof, thereby being able to reduce the amount of solder for a short-circuiting purpose as well as easily perform the short-circuit releasing operation.

Further, in the printed wiring board according to an embodiment of the present invention, the projection patterns are provided also in parts opposed to each other of the first anode pattern and the second anode pattern which are arranged in a fan-like form, thereby securing an advantage that even if one anode pattern is not electrically connected to the cathode pattern, it can electrically be connected to the cathode pattern by way of the other anode pattern.

### First Embodiment

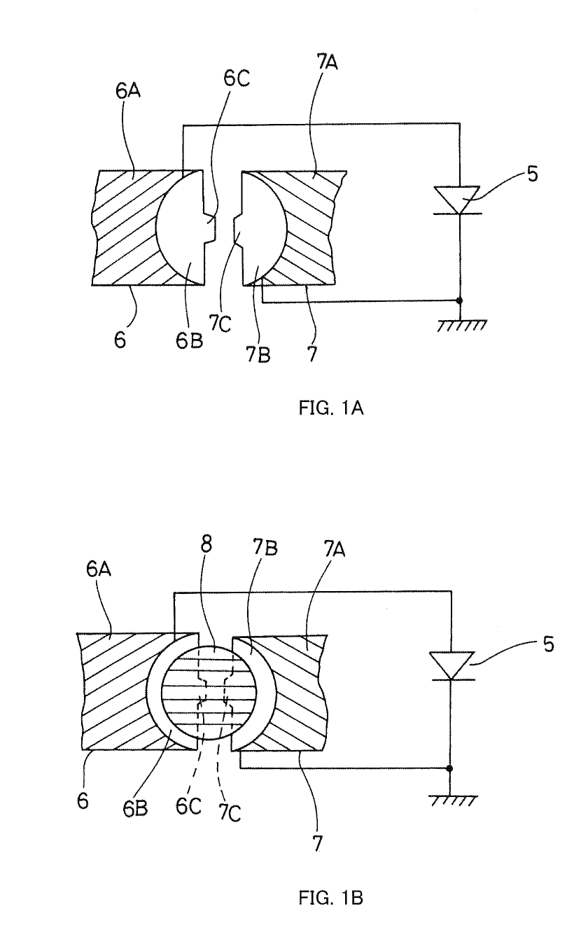

FIGS. 1A and 1B are explanatory diagrams of a first embodiment of the printed wiring board which is included in the optical pickup apparatus.

FIG. 1A is an explanatory diagram of a relationship of a pattern wired on the printed wiring board and a laser diode, and the printed wiring board is provided with an anode pattern 6 connected to an anode that is a power supply terminal of a laser diode 5 and a cathode pattern 7 connected to a cathode that is a ground terminal of the laser diode 5, for example.

In those figures, a hatched part 6A of the anode pattern 6 is a resist coating and a part thereof 6B not coated with the resist coating is an anode solder pattern which is to be soldered. Similarly, a hatched part 7A of the cathode pattern 7 is a resist coating and a part thereof 7B not coated with the resist coating is a cathode solder pattern to be soldered.

In such a part of the anode solder pattern 6B provided in the anode pattern 6 that is opposed to the cathode solder pattern 7B in an embodiment of the present invention, a projection pattern 6C is formed to project toward the cathode solder pattern 7B. In such a part of the cathode solder pattern 7B provided in the cathode pattern 7 that is opposed to the anode solder pattern 6B in an embodiment of the present invention, a projection pattern 7C is formed to project toward the anode solder pattern 6B. The projection pattern 6C and the projection pattern 7C are provided in such positions that they are opposed to each other as illustrated in the figure.

Soldering is performed in a state where a component such as the laser diode 5 is mounted on the printed wiring board on which the above-described patterns have been wired, and the soldering is performed by a method called reflow in an embodiment of the present invention as well. The reflow is a method of fixing an electronic component to the printed wiring board, which is called surface mounting, and a configuration is such that the electronic component is mounted in a state where cream solder is coated and then the electronic component is electrically fixed by means of soldering to the patterns, formed on the printed wiring board, by applying high temperature treatment thereto.

FIG. 1B depicts a state where the electronic component which is fixed onto the printed wiring board by a reflow soldering operation, and reference numeral 8 denotes the cream solder. That is to say, as is apparent from the figure, a state is such that the anode solder pattern 6B and the cathode solder pattern 7B are electrically connected by the cream solder 8, i.e., a state where they are short-circuited. The cream solder 8 acts as the solder for short-circuit.

In such a state, the anode that is the power supply terminal of the laser diode 5 and the cathode that is the ground terminal thereof are short-circuited, which results in a sate where the laser diode 5 can be protected from the electrostatic discharge.

In such a state, in the case where an operation of adjusting the optical pickup apparatus is performed by supplying a drive signal to the laser diode 5 or in the case where an operation of assembling it to the optical disc device is to be completed, it is required to release the state where the anode and the cathode of the laser diode 5 are short-circuited. Such an operation is performed by fusing the cream solder 8 which is the above-described solder for short circuit with a soldering iron, etc., to separate the anode solder pattern GB and the cathode solder pattern 7B as illustrated in FIG. 1A.

In such opposed parts of the anode solder pattern 6B provided in the anode pattern 6 and the cathode solder pattern 7B provided in the cathode pattern 7, which are wired on the printed wiring board using printing technology according to an embodiment of the present invention, the projection pattern 6C and the projection pattern 7C are provided to oppose each other as described above, and thus a wide part (first distance) and a narrow part (second distance) are formed in a space provided between the anode solder pattern 6B and the cathode solder pattern 7B. The second distance is a distance between the projection patterns 6C and 7C. The first distance is a distance between the anode solder pattern 6B and the cathode solder pattern 7B in such parts that the projection patterns 6C and 7C are not provided. The projection pattern 6C is formed in a substantially central position on such a side of the anode solder pattern 6B that is opposed to the cathode solder pattern 7B, and the projection pattern 7C is formed in a substantially central position on such a side of the cathode solder pattern 7B that is opposed to the anode solder pattern 6B.

With such a configuration, it is only necessary to perform soldering at least in a narrow part, thereby being able not only to perform an operation of short-circuiting with a small amount of solder but also to perform a reverse operation of releasing such short-circuit easily.

In the case where the projection pattern 6C and the projection pattern 7C are not provided in the anode solder pattern 6B and the cathode solder pattern 7B, respectively, and a distance between the anode solder pattern 6B and the cathode solder pattern 7B is reduced, if an operation of removing the solder is performed through the operation of releasing short-circuit, such a problem easily occurs that solder remains in end parts of the anode solder pattern 6B and the cathode solder pattern 7B in such a manner as to connect them, resulting in a short-circuit state being not released. In an embodiment of the present invention, however, the projection pattern 6C and the projection pattern 7C are provided therein, a distance between the anode solder pattern 6B and the cathode solder pattern 7B is reduced in such a position that the end parts of the anode solder pattern 6B and the cathode solder pattern 7B are excluded (i.e., a position where the projection pattern 6C and the projection pattern 7C are provided), and a length of sides opposed to each other of the projection pattern 6C and the projection pattern 7C is shorter than that of the end parts, thereby solving the problem that the solder remains in the operation of releasing short-circuit, resulting in the short-circuit state being not released.

### Second Embodiment

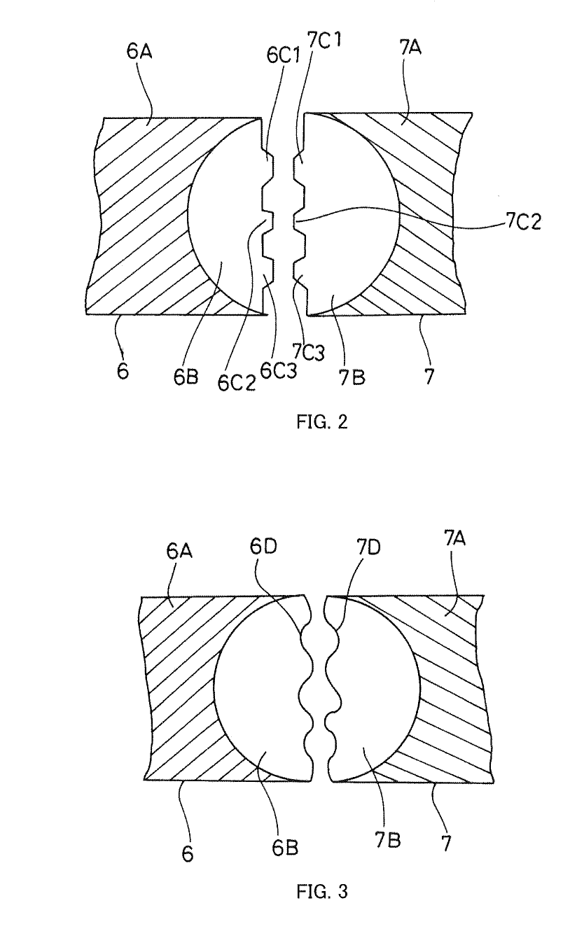

FIG. 2 depicts a second embodiment. As is apparent from the figure, three projection patterns 6C1, 6C2, 6C3 are formed in an opposed part of the anode solder pattern 6B which is opposed to the cathode solder pattern 7B, and three projection patterns 7C1, 7C2, and 7C3 are formed in an opposed part of the cathode solder pattern 7B which is opposed to the anode solder pattern 6B. That is to say, the projection patterns 6C1, 6C2, and 6C3 are provided side by side (i.e., arranged in parallel) at predetermined intervals on such a side of the anode solder pattern 6B that is opposed to the cathode solder pattern 7B, the projection patterns 7C1, 7C2, and 7C3 are provided side by side at predetermined intervals on such a side of the cathode solder pattern 7B that is opposed to the anode solder pattern 6B, and the projection patterns 6C1, 6C2, and 6C3 are opposed to the projection patterns 7C1, 7C2, and 7C3, respectively. The second distance is a distance between the projection patterns 6C1, 6C2, and 6C3 and the projection patterns 7C1, 7C2, and 7C3, respectively. The first distance is a distance between the anode solder pattern 6B and the cathode solder pattern 7B where the projection patterns 6C1, 6C2, and 6C3 and the projection patterns 7C1, 7C2, and 7C3 are not provided. The projection pattern 6C2 is formed in a substantially central position on such a side of the anode solder pattern 6B that is opposed to the cathode solder pattern 7B, and the projection pattern 7C2 is formed in a substantially central position on such a side of the cathode solder pattern 7B that is opposed to the anode solder pattern 6B. Thus, a wide part (first distance) and a narrow part (second distance) are formed in a space provided between the anode solder pattern 6B and the cathode solder pattern 7B.

With such a configuration, the operation of short-circuiting the anode solder pattern 6B and the cathode solder pattern 7B can be performed with a small amount of solder in the same manner as in a first embodiment of the present invention, thereby being able to perform the operation of short-circuiting and the operation of releasing short-circuit easily and securely.

Although the number of the projection patterns is set at three in this embodiment, needless to say, two or more projection patterns can be provided.

### Third Embodiment

FIG. 3 depicts a third embodiment. As is apparent from the figure, opposed parts 6D and 7D of the anode solder pattern 6B and the cathode solder pattern 7B are shaped in a wave form. In the case where the anode solder pattern 6B and the cathode solder pattern 7B are short-circuited by solder, it is only necessary to short-circuit by the solder at least such parts that a distance between the wave form of the anode solder pattern 6B and that of the cathode solder pattern 7B is the shortest (second distance). In such parts that the distance between the wave form of the anode solder pattern 6B and that of the cathode solder pattern 7B is the longest, for example, such a distance corresponds to the first distance (>second distance). That is to say, in a space in which the anode solder pattern 6B and the cathode solder pattern 7B are opposed, the first distance and the second distance are alternately repeated.

With such a configuration, the operation of short-circuiting the anode solder pattern 6B and the cathode solder pattern 7B can be performed with a small amount of solder in the same manner as in a first embodiment and a second embodiment of the present invention, thereby being able to perform the operation of short-circuiting and the operation of releasing short-circuit releasing easily and securely.

### Fourth Embodiment

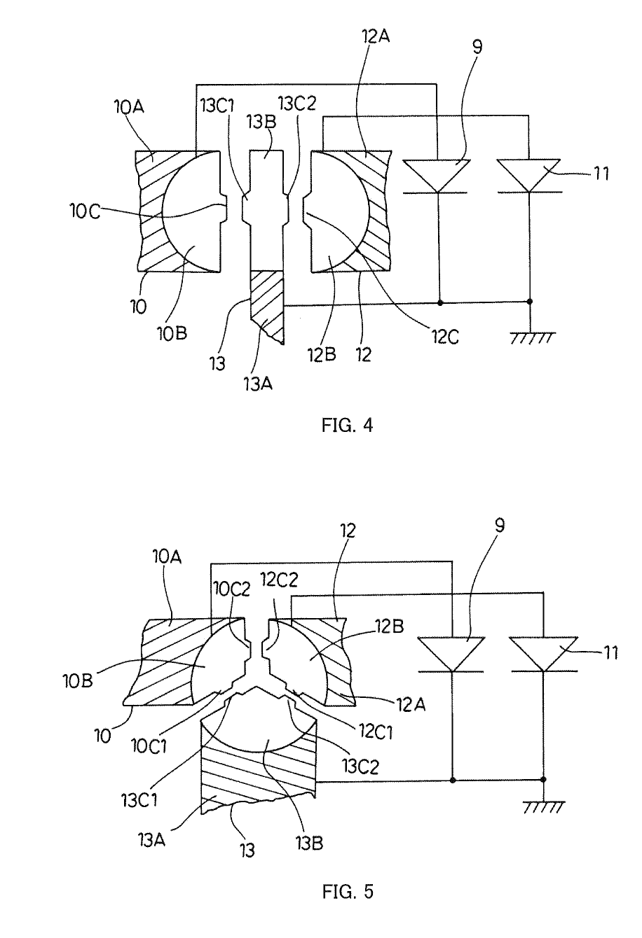

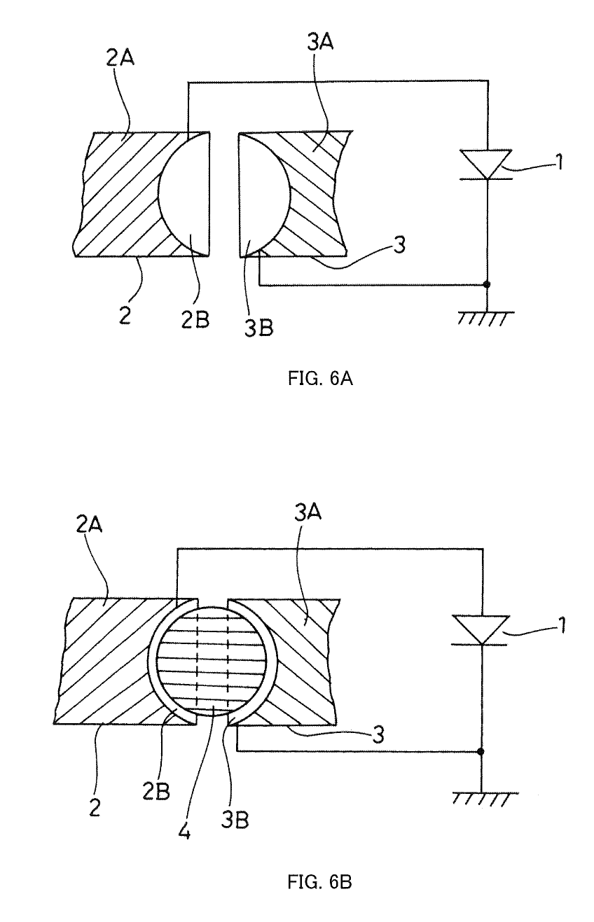

FIG. 4 depicts an embodiment in the case where the printed wiring board is implemented with respect to a two-wavelength laser diode in which two laser diodes are provided within one housing.

The printed wiring board depicted in FIG. 4 is provided with a first anode pattern 10 connected to an anode which is a power supply terminal of a first laser diode 9, a second anode pattern 12 connected to an anode a that is a power supply terminal of a second laser diode 11, and a cathode pattern 13 connected to a cathode that is a ground terminal of the first laser diode 9 as well as connected to a cathode that is a ground terminal of the second laser diode 11.

In the figure, a hatched part 10A of the first anode pattern 10 is a resist coating and a part thereof 10B not coated with the resist coating is a first anode solder pattern which is to be soldered. Similarly, a hatched part 12A of the second anode pattern 12 is the resist coating and a part thereof 12B not coated with the resist coating is a second anode solder pattern which is to be soldered. A hatched part 13A of the cathode pattern 13 is the resist coating and a part thereof 13B not coated with the resist coating is a cathode solder pattern which is to be soldered. The first anode pattern 10, the second anode pattern 12, and the cathode pattern 13 are arranged in a line and the cathode pattern 13 is arranged to be sandwiched between the first and the second anode patterns 10 and 12 so that the cathode pattern 13 is opposed to the first anode pattern 10 as well as the second anode pattern 12.

In such a part of the first anode solder pattern 10B provided in the first anode pattern 10 that is opposed to the cathode solder pattern 13B according to an embodiment of the present invention, a projection pattern 10C is formed to project toward the cathode solder pattern 13B. In such a part of the cathode solder pattern 13B provided in the cathode pattern 13 that is opposed to the first anode solder pattern 10B according to an embodiment of the present invention, a projection pattern 13C1 is formed to project toward the first anode solder pattern 10B. The projection pattern 10C and the projection pattern 13C1 are provided in such positions that they are opposed to each other as illustrated in the figure. Here, a distance between the projection pattern 10C and the projection pattern 13C1 is the second distance, and a distance between the first anode solder pattern 10B and the cathode solder pattern 13B opposed to each other excluding a distance between the projection pattern 10C and the projection pattern 13C1 is the first distance (>second distance).

In such a part of the second anode solder pattern 12B provided in the second anode pattern 12 that is opposed to the cathode solder pattern 13B, a projection pattern 12C is formed to project toward the cathode solder pattern 13B. In such a part of the cathode solder pattern 13B provided in the cathode pattern 13 that is opposed to the second anode solder pattern 12B according to an embodiment of the present invention, a projection pattern 13C2 is formed to project toward the second anode solder pattern 12B. The projection pattern 12C and the projection pattern 13C2 are provided in such positions that they are opposed to each other as illustrated in the figure. Here, a distance between the projection pattern 12C and the projection pattern 13C2 is a fourth distance, and a distance between the second anode solder pattern 12B and the cathode solder pattern 13B opposed to each other excluding a distance between the projection pattern 12C and the projection pattern 13C2 is a third distance (>fourth distance). The first distance and the third distance may be formed to be equal to each other and the second distance and the fourth distance may also be formed to be equal to each other.

The projection pattern 100 is formed in a substantially central position on such a side of the first anode solder pattern 10B that is opposed to the cathode solder pattern 13B; the projection pattern 12C is formed in a substantially central position on such a side of the second anode solder pattern 12B that is opposed to the cathode solder pattern 13B; the projection pattern 13C1 is formed in a substantially central position on such a side of the cathode solder pattern 13B that is opposed to the first anode solder pattern 10B; and further the projection pattern 13C2 is formed in a substantially central position on such a side of the cathode solder pattern 13B that is opposed to the second anode solder pattern 12B.

Soldering is performed in a state where a component such as the two-wavelength laser diode is mounted on the printed wiring board on which the above-described patterns have been wired, and the soldering is performed by a method called reflow in an embodiment of the present invention as well. The reflow is a method of fixing an electronic component to the printed wiring board, which is called surface mounting, and a configuration is such that the electronic component is mounted in a state where cream solder is coated and then the electronic component is electrically fixed by means of soldering to the patterns, formed on the printed wiring board, by applying the high temperature treatment thereto.

If such soldering has been performed, the first anode solder pattern 10B and the cathode solder pattern 13B, and the second anode solder pattern 12B and the cathode solder pattern 13B are electrically connected, respectively, namely, short-circuited by the cream solder.

In such a state, the anode that is the power supply terminal of the first laser diode 9 and the cathode that is the ground terminal thereof are short-circuited, which results in a sate where the first laser diode 9 can be protected from the electrostatic discharge. Similarly, the anode that is the power supply terminal of the second laser diode 11 and the cathode that is the ground terminal thereof are short-circuited, which results in a sate where the second laser diode 11 can be protected from the electrostatic discharge.

In such a state, in the case where an operation of adjusting the optical pickup apparatus is performed by supplying a drive signal to the first laser diode 9 and the second laser diode 11 or in the case where an operation of assembling it to the optical disc device is to be completed, it is required to release the state where the anodes and the cathodes of the first laser diode 9 and the second laser diode 11 are short-circuited. Such an operation is performed by fusing the cream solder which is the above-described solder for short circuit with a soldering iron, etc., to separate the first anode solder pattern 10B and the second anode solder pattern 12B from the cathode solder pattern 13B.

In such opposed parts of the first anode solder pattern 10B provided in the first anode pattern 10 and the cathode solder pattern 13B provided in the cathode pattern 13, which are wired on the printed wiring board using the printing technology according to an embodiment of the present invention, the projection pattern 10C and the projection pattern 13C1 are provided to oppose each other as described above, and thus a wide part (first distance) and a narrow part (second distance) are formed in a space provided between the first anode solder pattern 10B and the cathode solder pattern 13B.

Similarly, in such opposed parts of the second anode solder pattern 12B provided in the second anode pattern 12 and the cathode solder pattern 13B provided in the cathode pattern 13, the projection pattern 12C and the projection pattern 13C2 are provided to oppose each other as described above, and thus a wide part (third distance) and a narrow part (fourth distance) are formed in a space provided between the second anode solder pattern 12B and the cathode solder pattern 13B.

With such a configuration, it is only necessary to perform soldering at least in the narrow part, thereby being able not only to perform an operation of short-circuiting with a small amount of solder but also to perform a reverse operation of releasing such short-circuit easily.

An embodiment of the present invention, in which the cathode solder pattern 13B is arranged between the first anode solder pattern 10B and the second anode solder pattern 12B, has an advantage of being capable of common use of the cathode solder pattern 13B as an electrostatic discharge protecting pattern for both diodes.

In an embodiment of the present invention, one projection pattern is provided in each of such parts of the first anode solder pattern 10B and the cathode solder pattern 13B that are opposed to each other, and each of such parts of the second anode solder pattern 12B and the cathode solder pattern 13B that are opposed to each other, however, a plurality of projection patterns can be provided therein as described in a second embodiment of the present invention. The opposed parts of the first anode solder pattern 10B, the second anode solder pattern 12B, and the cathode solder pattern 13B can be shaped in a wave form as described in a third embodiment of the present invention.

### Fifth Embodiment

FIG. 5 depicts another embodiment in the case where the printed wiring board is implemented with respect to the two-wavelength laser diode in which two laser diodes are provided within one housing. Components equivalent to those illustrated in a fourth embodiment according to the present invention are designated by the same reference numerals.

A fifth embodiment is characterized in that the first anode solder pattern 10B of the first anode pattern 10, the second anode solder pattern 12B of the second anode pattern 12, and the cathode solder pattern 13B of the cathode pattern 13 each are shaped in a fan-like form and that the first anode solder pattern 10B, the second anode solder pattern 12B, and the cathode solder pattern 13B are arranged in a circular form.

In such a part of the first anode solder pattern 10B provided in the first anode pattern 10 that is opposed to the cathode solder pattern 13B according to an embodiment of the present invention, a projection pattern 10C1 is formed to project toward the cathode solder pattern 13B. In such a part of the cathode solder pattern 13B provided in the cathode pattern 13 that is opposed to the first anode solder pattern 10B according to an embodiment of the present invention, a projection pattern 13C1 is formed to project toward the first anode solder pattern 10B. The projection pattern 10C1 and the projection pattern 13C1 are provided in such positions that they are opposed to each other as illustrated in the figure.

In such a part of the second anode solder pattern 12B provided in the second anode pattern 12 that is opposed to the cathode solder pattern 13B, a projection pattern 12C1 is formed to project toward the cathode solder pattern 13B. In such a part of the cathode solder pattern 13B provided in the cathode pattern 13 that is opposed to the second anode solder pattern 12B according to an embodiment of the present invention, a projection pattern 13C2 is formed to project toward the second anode solder pattern 12B. The projection pattern 12C1 and the projection pattern 13C2 are provided in such positions that they are opposed to each other as illustrated in the figure.

Further, in an embodiment of the present invention where the solder patterns in the fan-like form are arranged in the circular form, the first anode solder pattern 10B and the second anode solder pattern 12B are arranged to oppose each other, and in such opposed parts thereof, projection patterns 10C2 and 12C2 are formed.

Soldering is performed in a state where a component such as the two-wavelength laser diode is mounted on the printed wiring board on which the above-described patterns have been wired, and the soldering is performed by a method called reflow in an embodiment of the present invention as well.

If such reflow soldering has been performed, the first anode solder pattern 10B and the cathode solder pattern 13B, the second anode solder pattern 12B and the cathode solder pattern 13B, and the first anode solder pattern 10B and the second anode solder pattern 12B are electrically connected, respectively, namely, short-circuited by the cream solder.

In such a state, the anode that is the power supply terminal of the first laser diode 9 and the cathode that is the ground terminal thereof are short-circuited, which results in a sate where the first laser diode 9 can be protected from the electrostatic discharge. Similarly, the anode that is the power supply terminal of the second laser diode 11 and the cathode that is the ground terminal thereof are short-circuited, which results in a sate where the second laser diode 11 can be protected from the electrostatic discharge.

In the above described short-circuit state, since the first anode solder pattern 10B and the second anode solder pattern 12B are electrically connected, even if the first anode solder pattern 10B and the cathode solder pattern 13B are in a state of being incompletely short-circuited, for example, the first anode solder pattern 10B is electrically connected to the cathode solder pattern 13B by way of the second anode solder pattern 12B. Therefore, the operation of short-circuiting among the solder patterns can securely be performed to protect the first laser diode 9 and the second laser diode 11 from the electrostatic discharge.

In such a state, in the case where an operation of adjusting the optical pickup apparatus is performed by supplying a drive signal to the first laser diode 9 and the second laser diode 11 or in the case where an operation of assembling it to the optical disc device is to be completed, it is required to release the state where the anodes and the cathodes of the first laser diode 9 and the second laser diode 11 are short-circuited. Such an operation is performed by fusing and removing the cream solder which is the above-described solder for short circuit with a soldering iron, etc., to release the short-circuit state of the first anode solder pattern 10B, the second anode solder pattern 12B, and the cathode solder pattern 13B.

In such opposed parts of the first anode solder pattern 10B provided in the first anode pattern 10 and the cathode solder pattern 13B provided in the cathode pattern 13, which are wired on the printed wiring board using the printing technology according to an embodiment of the present invention, the projection pattern 10C1 and the projection pattern 13C1 are provided to oppose each other as described above, and thus a wide part and a narrow part are formed in a space provided between the first anode solder pattern 10B and the cathode solder pattern 13B.

Similarly, in such opposed parts of the second anode solder pattern 12B provided in the second anode pattern 12 and the cathode solder pattern 13B provided in the cathode pattern 13, the projection pattern 12C1 and the projection pattern 13C2 are provided to oppose each other as described above, and thus a wide part and a narrow part are formed in a space provided between the second anode solder pattern 12B and the cathode solder pattern 13B.

Further, in such opposed parts of the first anode solder pattern 10B provided in the first anode pattern 10 and the second anode solder pattern 12B provided in the second anode pattern 12, the projection pattern 10C2 and the projection pattern 12C2 are provided to oppose each other as described above, and thus a wide part and a narrow part are formed in a space provided between the first anode solder pattern 10B and the second anode solder pattern 12B.

With such a configuration, it is only necessary to perform soldering at least in the narrow part, and thus not only an operation of short-circuiting can be performed with a small amount of solder but also a reverse operation of releasing such short-circuit can easily be performed.

In an embodiment of the present invention, one projection pattern is provided in each of such parts of the first anode solder pattern 10B and the second anode solder pattern 12B that are opposed to each other, each of such parts of the second anode solder pattern 12B and the cathode solder pattern 13B that are opposed to each other, and each of such parts of the first anode solder pattern 10B and the cathode solder pattern 13B that are opposed to each other, however, a plurality of projection patterns can be provided therein as described in a second embodiment of the present invention. The opposed parts of the first anode solder pattern 10B, the second anode solder pattern 12B, and the cathode solder pattern 13B can be shaped in a wave form as described in a third embodiment of the present invention.

The above embodiments of the present invention are simply for facilitating the understanding of the present invention and are not in any way to be construed as limiting the present invention. The present invention may variously be changed or altered without departing from its spirit and encompass equivalents thereof.

In an embodiment of the present invention, the solder patterns not coated with the resist coating are shaped in a semicircular shape, however, the shape can be changed in various manners. Further, the printed wiring board configured to protect the laser diode from the electrostatic discharge has been described herein, however, it can also be implemented with respect to other electronic components with a possibility of the electrostatic discharge.

What is claimed is:

1. A printed wiring board comprising:
an anode pattern electrically connected to an anode of a laser diode; and
a cathode pattern arranged to oppose the anode pattern and electrically connected to a cathode of the laser diode,
the anode pattern and the cathode pattern being in shapes having such parts that a distance between the anode pattern and the cathode pattern opposed to each other is a first distance, and such parts that a distance between the anode pattern and the cathode pattern opposed to each other is a second distance shorter than the first distance,
at least such parts that the distance between the anode pattern and the cathode pattern opposed to each other is the second distance being short-circuited by solder in a case where the laser diode is protected from an electrostatic discharge.

2. The printed wiring board of claim 1, wherein
the anode pattern includes a first projection pattern projecting toward the cathode pattern,
the cathode pattern includes a second projection pattern projecting toward the anode pattern,
the first projection pattern and the second projection pattern are opposed to each other, and
a distance between the first projection pattern and the second projection pattern opposed to each other is the second distance.

3. The printed wiring board of claim 2, wherein
the first projection pattern is formed in a substantial center on such a side of the anode pattern that is opposed to the cathode pattern, and
the second projection pattern is formed in a substantial center on such a side of the cathode pattern that is opposed to the anode pattern.

4. The printed wiring board of claim 2, wherein
a plurality of the first projection patterns are arranged in parallel on such a side of the anode pattern that is opposed to the cathode pattern, and
a plurality of the second projection patterns are arranged in parallel on such a side of the cathode pattern that is opposed to the anode pattern.

5. The printed wiring board of claim 1, wherein
the anode pattern and the cathode pattern are in such a wave form that the distances between the anode pattern and the cathode pattern opposed to each other are alternately the first distance and the second distance.

6. The printed wiring board of claim 1, wherein
the anode of the laser diode is an electrode to be supplied with a drive signal, and
the cathode of the laser diode is an electrode to be grounded.

7. A printed wiring board comprising:
a first anode pattern electrically connected to an anode of a first laser diode;
a second anode pattern electrically connected to an anode of a second laser diode; and
a cathode pattern arranged to oppose the first and second anode patterns and electrically connected to cathodes of the first and second laser diodes,
the first anode pattern and the cathode pattern being in shapes having such parts that a distance between the first anode pattern and the cathode pattern opposed to each other is a first distance, and such parts that a distance between the first anode pattern and the cathode pattern opposed to each other is a second distance shorter than the first distance,
the second anode pattern and the cathode pattern being in shapes having such parts that a distance between the second anode pattern and the cathode pattern opposed to each other is a third distance, and such parts that a distance between the second anode pattern and the cathode pattern opposed to each other is a fourth distance shorter than the third distance,
at least such parts that the distance between the first anode pattern and the cathode pattern opposed to each other is the second distance being short-circuited by solder in a case where the first laser diode is protected from an electrostatic discharge, and
at least such parts that the distance between the second anode pattern and the cathode pattern opposed to each other is the fourth distance being short-circuited by solder in a where case the second laser diode is protected from the electrostatic discharge.

8. The printed wiring board of claim 7, wherein
the cathode pattern is arranged between the first and second anode patterns to oppose the first and second anode patterns.

9. The printed wiring board of claim 7, wherein
the first anode pattern includes a first projection pattern projecting toward the cathode pattern,
the second anode pattern includes a second projection pattern projecting toward the cathode pattern,
the cathode pattern includes a third projection pattern and a fourth projection pattern projecting toward the first anode pattern and the second anode pattern, respectively,
the first projection pattern and the third projection pattern are opposed to each other,
a distance between the first projection pattern and the third projection pattern opposed to each other is the second distance,
the second projection pattern and the fourth projection pattern are opposed to each other, and
a distance between the second projection pattern and the fourth projection pattern opposed to each other is the fourth distance.

10. The printed wiring board of claim 9, wherein
the first projection pattern is formed in a substantial center on such a side of the first anode pattern that is opposed to the cathode pattern,
the second projection pattern is formed in a substantial center on such a side of the second anode pattern that is opposed to the cathode pattern,
the third projection pattern is formed in a substantial center on such a side of the cathode pattern that is opposed to the first anode pattern, and
the fourth projection pattern is formed in a substantial center on such a side of the cathode pattern that is opposed to the second anode pattern.

11. The printed wiring board of claim 9, wherein
a plurality of the first projection patterns are arranged in parallel on such a side of the first anode pattern that is opposed to the cathode pattern,
a plurality of the second projection patterns are arranged in parallel on such a side of the second anode pattern that is opposed to the cathode pattern,
a plurality of the third projection patterns are arranged in parallel on such a side of the cathode pattern that is opposed to the first anode pattern, so as to oppose the first projection patterns, and
a plurality of the fourth projection patterns are arranged in parallel on such a side of the cathode pattern that is opposed to the second anode pattern, so as to oppose the second projection patterns.

12. The printed wiring board of claim 7, wherein
the first anode pattern and the cathode pattern are in such a wave form that the distances between the first anode pattern and the cathode pattern opposed to each other are alternately the first distance and the second distance, and
the second anode pattern and the cathode pattern are in such a wave form that the distances between the second anode pattern and the cathode pattern opposed to each other are alternately the third distance and the fourth distance.

13. The printed wiring board of claim 7, wherein
the anode of the laser diodes is an electrode to be supplied with a drive signal, and
the cathode of the laser diodes is an electrode to be grounded.

14. The printed wiring board of claim 7, wherein
the first distance is equal to the third distance, and
the second distance is equal to the fourth distance.

15. The printed wiring board of claim 7, wherein
each of the first anode pattern, the second anode pattern, and the cathode pattern is in a fan-like form, and
the first anode pattern, the second anode pattern, and the cathode pattern are arranged to be in a circular form.
